(19) United States
(12) Patent Application Publication
(10) Pub. No.: US 2025/0214850 A1
(43) Pub. Date: Jul. 3, 2025

(54) EWT FRAMEWORK MOLECULAR SIEVES, MANUFACTURING PROCESSES AND USES THEREOF

(71) Applicant: ExxonMobil Chemical Patents Inc., Baytown, TX (US)

(72) Inventors: Sina SARTIPI, Willebroek (BE); Roxana Perez Velez, Leuven (BE); Scott Weigel, Allentown, PA (US); Mariame Akouche, Carriere sur Seine (FR); Valentin Valtchev, Basly (FR); Jean-Pierre Gilson, Fouesnant (FR)

(21) Appl. No.: 19/003,618

(22) Filed: Dec. 27, 2024

Related U.S. Application Data
(63) Continuation of application No. PCT/EP2023/067250, filed on Jun. 26, 2023.

(30) Foreign Application Priority Data
Jul. 6, 2022 (EP) 22183386.6

(51) Int. Cl. C01B 39/02; B01J 29/70; C01B 39/48

(52) U.S. Cl. CPC C01B 39/026; B01J 29/70; C01B 39/48; C01P 2002/72; C01P 2002/86

(57) ABSTRACT

Modified EWT framework zeolites are provided, including processes for making such modified EWT framework zeolites and uses of such modified EWT framework zeolites. The modified EWT framework zeolites can be formed based on contacting a EWT framework zeolite with an aqueous solution of an aluminum salt multiple times, such as performing the contacting 2 to 10 times.

### CROSS REFERENCE TO RELATED APPLICATION

This application is a Continuation of PCT/EP2023/067250, filed Jun. 26, 2023, and titled “EWT FRAMEWORK MOLECULAR SIEVES, MANUFACTURING PROCESSES AND USES THEREOF”, which claims the benefit of priority to European Application No. 22183386.6, filed on Jul. 6, 2022, which is hereby incorporated by reference in its entirety.

### FIELD

This disclosure relates to EWT framework molecular sieves, processes of making such molecular sieves, and uses of these molecular sieves. More particularly, the invention concerns a process for increasing the concentration of aluminum in an EWT framework molecular sieve.

### BACKGROUND

EWT framework molecular sieves include zeolites such as EMM-23. EMM-23 is a crystalline or substantially crystalline material. It is described as a molecular sieve in U.S. Pat. No. 9,205,416, the content of which is incorporated herein by reference in its entirety. Framework structures are approved by the Structure Commission of the International Zeolite Association and are described in the Database of Zeolite Structures. Molecular sieves can be used as adsorbents, catalysts or supports for catalysts, especially for hydrocarbon conversions. EMM-23 has a crystalline structure that can be identified by X-ray diffraction (XRD) as described in U.S. Pat. No. 9,205,416. EMM-23 has uniform cavities and pores that are interconnected by channels. The sizes and dimensions of the cavities and the pores allow for adsorption of molecules of certain sizes. Due to its ability to adsorb molecules through size selections, EMM-23 has many uses including hydrocarbon conversions, e.g., cracking, hydrocracking, disproportionation, alkylation, oligomerization, and isomerization.

EWT framework molecular sieves such as EMM-23 can be prepared from a mixture of sources of water, hydroxide ions, SiO₂, optionally Al, and a structure directing agent. The structure directing agent may be an organic molecule such as a diquaternary ammonium molecule. Molecular sieves as-made from these sources may contain the structure directing agent in the crystalline framework. Thermal treatment (e.g., calcination) of the as-made molecular sieve would generate the molecular sieve free of the structure directing agent.

The inclusion of a trivalent element such as aluminum in a molecular sieve may result in modified properties such as increased acidity, which can enhance catalytic activity. It can be difficult to directly synthesize EWT framework molecular sieves with the desired level of aluminum content. In particular, it has proved difficult to crystallize EMM-23 having a framework SiO₂: Al₂O₃ ratio of less than 100. While EMM-23 has been previously described in U.S. Pat. No. 9,205,416, and processes for modifying EMM-23 are described in US 2019/0030518 A1 and US 2019/0031519 A1, there remains a desire for modified materials of EMM-23 with improved properties.

### SUMMARY

The present disclosure provides improved processes of preparing EWT framework zeolites with increased aluminum content. More particularly, the invention concerns a process in which the aluminum content of an EWT zeolite is increased by means of repeated treatments with an aqueous solution of an aluminum salt.

In a first aspect, the invention provides a process for increasing the aluminum content of an EWT framework zeolite and mixtures thereof comprising subjecting the EWT framework zeolite to a treatment which includes the steps of:
a) contacting the EWT framework zeolite with an aqueous solution of an aluminum salt; and
b) separating the EWT framework zeolite from the aqueous solution of the aluminum salt;
and repeating the treatment such that the EWT framework zeolite is subjected in total to n treatment cycles, where n is a number in the range from 2 to 10.

The inventors have found that the process of the first aspect of the invention is unexpectedly effective to incorporate aluminum into the EWT framework zeolite, thereby making it possible to provide EWT framework zeolites in which the ratio Si:Al₂ is 70 or lower.

In a second aspect, the invention provides an EWT framework zeolite produced by a process according to the first aspect, in which the ratio Si:Al₂ is 70 or lower.

In a third aspect, the invention provides a process of converting an organic compound to a conversion product which comprises the step of contacting the organic compound with an EWT framework zeolite according the second aspect.

EMM-23 is a preferred EWT framework zeolite.

As used herein the ratios SiO₂: Al₂O₃ and Si:Al₂ have the same meaning and are molar ratios.

Any two or more of the features described in this specification, including in this summary section, can be combined to form combination of features not specifically described herein. The details of one or more features are set forth in the accompanying drawings and the description below. Other features and advantages will be apparent from the description and drawings, and from the claims.

### DESCRIPTION OF THE DRAWINGS

FIG. 1 shows powder XRD pattern of as-made EMM-23 prepared in Example 1.

FIG. 2 shows 27Al MAS NMR spectrum of as-made EMM-23 prepared in Example 1.

FIG. 3 shows powder XRD pattern of calcined EMM-23 prepared in Example 2.

FIG. 4 shows 27 Al MAS NMR spectrum of calcined EMM-23 prepared in Example 2.

FIG. 5 shows powder XRD pattern of treated EMM-23 prepared in Example 3.

FIG. 6 shows powder XRD pattern of treated EMM-23 prepared in Example 4.

FIG. 7 shows powder XRD pattern of treated EMM-23 prepared in Example 5.

FIG. 8 shows powder XRD pattern of treated EMM-23 prepared in Example 6.

FIG. 9 shows powder XRD patterns of treated EMM-23 prepared in Example 7.

FIG. 10 shows 27Al MAS NMR spectra of calcined EMM-23 prepared in Example 2 and the treated EMM-23 prepared in Examples 7 to 12.

FIG. 11A shows overlaid powder XRD patterns of calcined EMM-23 of Examples 2, 3, 6 to 13 and 15.

FIG. 11B shows overlaid powder XRD patterns of as-made EMM-23 of Examples 1, 4, 5, 14 and 16.

### DETAILED DESCRIPTION

Provided herein are various modified EWT framework zeolites, processes of preparing these zeolites, and uses thereof. The as-made EWT framework zeolite (i.e., before thermal treatment or other treatment to remove the structure directing agent (SDA), which may be referred to herein as “as-synthesized”, or “as-made”) may include the structure directing agent (SDA), as one of the reagents of the synthesis. Thermal treatment (e.g., calcination) of the as-made EMM-23 typically exposes the materials to high temperatures, e.g., to 400-600° C., in an atmosphere selected from air, nitrogen, or a mixture thereof, to remove the SDA. The thermally-treated (e.g., calcined) form of the EWT framework zeolite may be described as having a chemical composition of oxides of a trivalent element (e.g., Al₂O₃) and oxides of a tetravalent element (e.g., SiO₂), where these oxides can be in various molar ratios.

The concentration of aluminum in a zeolite is often expressed in terms of the molar ratio of silica to alumina, that is, the SiO₂: Al₂O₃ ratio. That is often abbreviated to the Si:Al₂ ratio, and for the purposes of the present disclosure the expressions Si:Al₂ and SiO₂: Al₂O₃ should be taken as being equivalent. Sometimes the concentration of aluminum in a zeolite is expressed as a ratio of silicon atoms to aluminum atoms, that is, Si:Al. A ratio expressed as Si:Al will be numerically half the ratio expressed as Si:Al₂. For example, a ratio Si:Al=75 corresponds to Si:Al₂ of 150.

### Incorporation of Additional Aluminum

Provided herein are additional modified EWT framework zeolites that include a relatively large amount of aluminum. Modified EWT framework zeolite having more aluminum is more stable during thermal treatment (e.g., calcination) or in its final thermally-treated form than a material with less aluminum. It can be difficult to prepare an EWT framework zeolite, for example an EMM-23 zeolite, having an atomic ratio of Si to Al of less than 75 (e.g., Si:Al less than 75, corresponding to Si:Al₂ of less than 150). One possible route to incorporate more aluminum into an EWT framework zeolite is by increasing the amount of aluminum source(s) in the mixture to prepare the as-made EWT framework zeolite. However, in practice, such a process does not incorporate much additional aluminum into the EWT framework zeolite and the reproducibility of the synthesis appears to be sensitive to the presence of aluminum and can lead to undesirable impurities. Described herein are aluminum modified EWT framework zeolites having a molar ratio Si:Al₂ of less than 70 prepared by a process that involves incorporating the Al into the EWT framework zeolite (i.e., the already prepared EWT framework zeolite) by repeated cycles of treatment with an aqueous solution of an aluminum salt.

In the process of the first aspect of invention the steps a) and b) are carried out in that order. Carrying out those steps a) and b) a single time constitutes a treatment cycle. If those steps are only carried out a single time, then there is only one treatment cycle and n=1. The inventors have found that the amount of additional aluminum incorporated in the zeolite tends to diminish as the cycle number increases. In the method of the invention, the treatment cycle is carried out a first time and then is repeated at least once and no more than nine times, so that the total number of treatment cycles n is in the range of from 2 to 10. Optionally, n is in the range of from 2 to 8, optionally from 3 to 6.

In step a) the contact time in which the EWT framework zeolite is contacted with the aqueous solution of the aluminum salt may be any suitable duration. Optionally, in step a) the EWT framework zeolite is contacted with the aqueous solution of the aluminum salt for a duration in the range of from 0.25 hour to 24 hours, optionally from 1 hour to 24 hours, optionally from 2 hours to 6 hours.

Any aluminum salt which is at least partially soluble in water may be used in the treatment. Preferably, the aluminum salt will be soluble in water at 25° C. to at least 0.05 wt %, preferably at least 0.1 wt %. Suitable salts may be selected from Al(NO₃)₃, Al₂ (SO₄)₃, AlCl₃, (NH₄)₃AlF₆, or a mixture thereof. For example, the aluminum salt may comprise or be Al(NO₃)₃.

Each treatment cycle of the process of the first aspect of the invention may independently optionally comprise one or more additional steps. Optionally, in one or more of the treatment cycles the treatment also includes, after step b), the step of: c) washing the EWT framework zeolite with a wash liquid. Optionally, in all of the treatment cycles the treatment also includes, after step b), the step of: c) washing the EWT framework zeolite with a wash liquid.

Typically, the wash liquid will be an aqueous liquid. For example, the wash liquid may be water, in particular water having a pH of between 6.0 and 8.0. The wash liquid may suitably be chosen from distilled water and deionized water. Alternatively, the wash liquid may be an alkaline aqueous solution, such as aqueous ammonium hydroxide or, e.g., an aqueous alkali or alkaline earth metal hydroxide (followed by exchange of the alkali or alkaline earth metal(s) with ammonium ions, including, e.g., NH₄+, tetraalkylammoniums suchs as tetramethylammonium, tetraethylammonium, tetrapropylammonium, and so-called diquats, such as C₃, C₄, C₅ or C₆ diquats), preferably aqueous ammonium hydroxide. The use of an alkaline wash liquid such as aqueous ammonium hydroxide promotes removal of octahedrally-coordinated aluminum, the removal of which may lead to greater selectivity in any reaction in which the zeolite is used as a catalyst. However, contact with alkaline solution will also tend to reduce the degree of crystallinity of the zeolite, and so the pH of the alkaline wash liquid and the duration and conditions of the washing step must be chosen with that in mind to avoid excessive degradation of the crystal structure. Where more than one of the treatment cycles includes a washing step c), different wash liquids may be used in different cycles. For example, some treatment cycles may use neutral water having a pH of between 6.0 and 8.0, whereas other treatment cycles may use an alkali wash liquid, such as aqueous ammonium hydroxide. Optionally, at least one treatment cycle includes a washing step c) in which the wash liquid is alkaline, for example, aqueous ammonium hydroxide.

The separation step b) may involve separating the EWT framework zeolite from the aqueous solution of the aluminum salt by any suitable technique. For example, the separation may involve filtration or centrifugation. The separation step b) will typically remove at least 90 wt % of the aqueous solution of the aluminum salt, and will preferably remove substantially all of the aqueous solution of the aluminum salt to leave the zeolite as a wet solid. As mentioned above, the wet solid may then be subjected to an optional washing step c). Optionally, the wet solid may be subjected to an optional step d) of drying the EWT framework zeolite. The drying step d) may take place directly after step b), if there is no washing step c), or after the washing step c), if present.

The optional drying step d) may include contact with heated air, for example at a temperature in the range of from 40° C. to 200° C., optionally from 50° C. to 100° C. The duration of the drying step may optionally be from 1 hour to 24 hours, for example, from 3 hours to 12 hours.

Typically, the final treatment cycle will include a drying step d) to leave the zeolite as a dried zeolite at the end of the process. Optionally, only the final treatment cycle involves a drying step d).

The contacting step a) may be carried out in any suitable vessel. For example, step a) may be carried out as a batch process in a stirred tank reactor. Advantageously, step a) is carried out at a temperature of greater than 40° C., preferably in the range of from 50° C. to 100° C., more preferably in the range of from 60° C. to 95° C. Although it is possible to carry out step a) at elevated pressure, for example in an autoclave, in order to increase the temperature above 100° C., it will generally be convenient to carry out step a) at atmospheric ambient pressure.

Optionally, the EWT framework zeolite is an uncalcined or “as-made” EWT framework zeolite. Such uncalcined or as-made zeolites will typically contain an amount of structure directing agent (SDA) within its pore structure. If the EWT framework zeolite is an uncalcined or “as-made” EWT framework zeolite then the process of the invention may include, following the final treatment cycle, a step of calcining the zeolite to remove the SDA. Alternatively, the EWT framework zeolite used in the process of the first aspect of the invention is a calcined EWT framework zeolite.

Preferably, the EWT framework zeolite is EMM-23, and is optionally calcined EMM-23.

The EWT framework zeolite used in the process of the first aspect of the invention may be in any suitable form. For example, the EWT framework zeolite may be in the form of unbound zeolite crystals. Alternatively, the EWT framework zeolite may be in the form of pellets or granules comprising a binder.

As noted above, in a second aspect, the invention provides an EWT framework zeolite produced by a process according to the first aspect, in which the ratio Si:Al₂ is 70 or lower. Optionally, the ratio Si:Al₂ is 60 or lower, optionally 55 or lower. Optionally, the ratio Si:Al₂ is at least 15, optionally at least 20. The ratio Si:Al₂ may be from 15 to 70, for example from 20 to 60.

As also noted above, in a third aspect, the invention provides a process of converting an organic compound to a conversion product which comprises the step of contacting the organic compound with an EWT framework zeolite according the second aspect. Preferably, the EWT framework zeolite according the second aspect of the invention is EMM-23.

EMM-23 used in the process of the first aspect of the invention may be substantially free of one or more impurities (e.g., at least 50%, at least 60%, at least 70%, at least 80%, at least 90%, at least 95%, at least 97%, or at least 99% by weight of the EMM-23 is free of impurities (i.e., is the weight percentage based on the total weight of the material that is the EMM-23 and not impurities)), such as zeolite beta, ZSM-5, or a mixture thereof. EMM-23 used in the process may be substantially free of one or more impurities such that no other phase such as zeolite beta, ZSM-5, or a mixture thereof can be identified in the XRD pattern of the modified EMM-23 material.

The EMM-23 may have an alpha value of greater than 10. The alpha value of the EMM-23 may be greater than 20, greater than 30, greater than 40, or greater than 50. In some examples, the alpha value may be from 15 to 50, 20 to 40, or 30 to 35.

The EMM-23 may have a micropore volume greater than 0.15 cc/g. The micropore volume may be from 0.15 to 0.30, 0.25 to 0.30 cc/g, or 0.20 to 0.30 cc/g. The EMM-23 may have a cell a-parameter of 19.6±0.5 Å and c-parameter of 13.5±0.5 Å.

The EMM-23 optionally has at least four XRD peaks having degree 2-theta values selected from Table 1:

TABLE 1

| degree 2-theta | Relative intensity |
|---|---|
| (±0.20) | [100 × I/(Io)] (±30%) |
| 5.23 | 100 |
| 8.40 | 32 |
| 9.06 | 68 |
| 15.98 | 15 |
| 23.81 | 50 |
| 24.07 | 15 |

The EMM-23 optionally has at least four XRD peaks with the degree 2-theta and d-spacing values selected from Table 2, wherein the d-spacing values have a deviation determined based on the corresponding deviation ±0.20 degree 2-theta when converted to the corresponding values for d-spacing using Bragg's law.

TABLE 2

| degree 2-theta | d-spacing | Relative intensity |
|---|---|---|
| (±0.20) | (Å) | [100 × I/(Io)] (±30%) |
| 5.23 | 16.87 | 100 |
| 8.40 | 10.51 | 32 |
| 9.06 | 9.76 | 68 |
| 15.98 | 5.54 | 15 |
| 23.81 | 3.73 | 50 |
| 24.07 | 3.69 | 15 |

Optionally, the EMM-23 has at least five or six XRD peaks selected from Table 1 or Table 2. The EMM-23 may have at least four, at least five, or six XRD peaks with 2-theta values selected from Table 1 or 2 and a micropore volume greater than 0.15 cc/g (e.g., 0.15 to 0.30, 0.25 to 0.30 cc/g. or 0.20 to 0.30 cc/g), or a unit cell a-parameter of 19.6+0.5 Å and c-parameter of 13.5+0.5 Å.

Optionally, the EMM-23 has at least four XRD peaks with degree 2-theta values selected from Table 3:

TABLE 3
intensity

| degree 2-theta | Relative intensity |
|---|---|
| (±0.20) | [100 × I/(Io)] (±30%) |
| 5.23 | 100 |
| 8.40 | 32 |
| 9.06 | 68 |
| 15.33 | 13 |
| 15.98 | 15 |
| 20.97 | 12 |
| 23.81 | 50 |
| 24.07 | 15 |
| 24.22 | 12 |
| 24.95 | 14 |

Optionally, the EMM-23 has at least four XRD peaks with the degree 2-theta and d-spacing values selected from Table 4, wherein the d-spacing values have a deviation determined based on the corresponding deviation ±0.20 degree 2-theta when converted to the corresponding values for d-spacing using Bragg's law:

TABLE 4
d-spacing

| degree 2-theta | d-spacing | Relative intensity |
|---|---|---|
| (±0.20) | (Å) | [100 × I/(Io)] (±30%) |
| 5.23 | 16.87 | 100 |
| 8.40 | 10.51 | 32 |
| 9.06 | 9.76 | 68 |
| 15.33 | 5.78 | 13 |
| 15.98 | 5.54 | 15 |
| 20.97 | 4.23 | 12 |
| 23.81 | 3.73 | 50 |
| 24.07 | 3.69 | 15 |
| 24.22 | 3.67 | 12 |
| 24.95 | 3.57 | 14 |

Optionally, the EMM-23 has at least five, at least six, at least seven, at least eight, at least nine, or ten XRD peaks with the degree 2-theta values selected from Table 3 or Table 4. The EMM-23 may have at least four, at least, five, at least six, at least seven, at least eight, at least nine, or ten XRD peaks with the degree 2-theta values selected from Table 3 or Table 4 and a micropore volume greater than 0.15 cc/g (e.g., 0.15 to 0.30, 0.25 to 0.30 cc/g, or 0.20 to 0.30 cc/g), or a unit cell a-parameter of 19.6±0.5 Å and c-parameter of 13.5±0.5 Å.

The EMM-23 optionally has at least four XRD peaks with degree 2-theta values selected from Table 5:

TABLE 5

| degree 2-theta | Relative intensity |
|---|---|
| (±0.20) | [100 × I/(Io)] (±30%) |
| 5.23 | 100 |
| 8.40 | 32 |
| 9.06 | 68 |
| 14.16 | 10 |
| 15.33 | 13 |
| 15.98 | 15 |
| 20.56 | 10 |
| 20.97 | 12 |
| 23.81 | 50 |
| 24.07 | 15 |
| 24.22 | 12 |
| 24.95 | 14 |

The EMM-23 optionally has at least four XRD peaks with the degree 2-theta and d-spacing values selected from Table 6, wherein the d-spacing values have a deviation determined based on the corresponding deviation ±0.20 degree 2-theta when converted to the corresponding values for d-spacing using Bragg's law:

TABLE 6

| degree | d-spacing | Relative intensity |
|---|---|---|
| (±0.20)2-theta | (Å) | [100 × I/(Io)] (±30%) |
| 5.23 | 16.87 | 100 |
| 8.40 | 10.51 | 32 |
| 9.06 | 9.76 | 68 |
| 14.16 | 6.25 | 10 |
| 15.33 | 5.78 | 13 |
| 15.98 | 5.54 | 15 |
| 20.56 | 4.32 | 10 |
| 20.97 | 4.23 | 12 |
| 23.81 | 3.73 | 50 |
| 24.07 | 3.69 | 15 |
| 24.22 | 3.67 | 12 |
| 24.95 | 3.57 | 14 |

The EMM-23 optionally has at least five, at least six, at least seven, at least eight, at least nine, at least ten, at least eleven, or twelve XRD peaks with degree 2-theta values selected from Table 5 or Table 6. The EMM-23 optionally has at least four, at least five, at least six, at least seven, at least eight, at least nine, at least ten, at least eleven, or twelve XRD peaks with degree 2-theta values selected from Table 5 or Table 6 and a micropore volume greater than 0.15 cc/g (e.g., 0.15 to 0.30, 0.25 to 0.30 cc/g, or 0.20 to 0.30 cc/g), or a unit cell a-parameter of 19.6±0.5 Å and c-parameter of 13.5±0.5 Å. For the avoidance of doubt, the XRD peaks of the EMM-23 of the invention may have intensities differing from those listed in Tables 1 to 6 above.

As noted above, in a second aspect, the invention provides an EWT framework zeolite produced by a process according to the first aspect, in which the ratio Si:Al₂ is 70 or lower. Optionally, the ratio Si:Al₂ is 60 or lower, optionally 55 or lower. Optionally, the ratio Si:Al₂ is at least 15, optionally at least 20. The ratio Si:Al₂ may be from 15 to 70, for example from 20 to 60. In a preferred embodiment, the EWT framework zeolite of the second aspect of the invention is EMM-23. The EMM-23 according to the second aspect of the invention will have a modified XRD pattern but may optionally retain a number of the same XRD peaks with the same degree 2-theta and/or d-spacing values as described above in relation to the EMM-23 used in the process of the first aspect with reference to Tables 1 to 6.

### Preparation of EMM-23

An as-made EMM-23 (e.g., a material before thermal treatment to remove SDA) may be prepared from a mixture of sources of water, hydroxide ions, Si, optionally Al, and optionally a structure directing agent SDA.

For example, the molar ratios in the mixture may be as follows:
SiO₂/Al₂O₃ may be at least 5 (e.g., at least 100, at least 1000, or all SiO₂);
H₂O/SiO₂ may be 0.5 to 50 (e.g., 2 to 10 or 14-40);
OH⁻/SiO₂ may be 0.1 to 1.0 (e.g., 0.2 to 0.5); and
SDA/SiO₂ may be 0.05 to 0.5 (e.g., 0.1 to 0.25).

In one or more aspects, the molar ratios of these sources in the as-made EMM-23 that is subsequently thermally-treated to generate calcined EMM-23 may be as follows: SiO₂/Al₂O₃ may be equal to or at least 75 (e.g., at least 100, at least 1000, or all SiO₂);
H₂O/SiO₂ may be 0.5 to 50 (e.g., 2 to 10 or 14-40);
OH⁻/SiO₂ may be 0.1 to 1.0 (e.g., 0.2 to 0.5); and SDA/SiO₂ may be 0.05 to 0.5 (e.g., 0.1 to 0.25).

In one or more aspects, the as-made EMM-23 material may be prepared by mixing a source of Al with a hydroxide solution of SDA, and then subsequently adding a source of Si to the mixture to form a base mixture of the components. Seeds of an EMM-23 material may be added to the base mixture. The solvent (e.g., water from the hydroxide solution, and optionally methanol and ethanol from the hydrolysis of silica sources) of the base mixture may be removed (e.g., by evaporation or freeze-drying) such that a desired solvent to SiO₂ molar ratio is achieved for the resulting mixture. Water may be added to the resulting mixture to achieve a desired H₂O/SiO₂ molar ratio when too much water is removed during the solvent removal process. The mixture is then sealed within a suitable reactor vessel, e.g., within a steel Paar autoclave. The sealed mixture is heated, optionally with tumbling or stirring, such that the sealed mixture is maintained at a temperature for a period of time sufficient for EMM-23 crystals to form (e.g., in a sealed autoclave placed in a convection oven maintained at 150° C. for 1 day to 14 days). Detailed procedures for the preparation of an as-made EMM-23 material can also be found in U.S. Pat. No. 9,205,416, which is incorporated herein by reference in its entirety.

Examples of sources of the Si may be selected from colloidal suspensions of silica, precipitated silica, fumed silica, alkali metal silicates, and/or tetraalkyl orthosilicates (e.g., tetraethyl orthosilicates, tetramethyl orthosilicates, etc.). Examples of different sources of silica may include LUDOX® (e.g., LUDOX® AS-40) colloidal silica, precipitated silicas such as ULTRASIL®, SIPERNAT® products, and HI-SIL® products, CARBOSPERSE™ fumed silica suspension, and CAB-O-SIL® fumed silica, or a mixture thereof.

The source of Al may comprise or be aluminum and other suitable sources of aluminum may be selected from hydrated alumina, aluminum hydroxide, alkali metal aluminates, aluminum alkoxides, and water-soluble aluminum salts, such as aluminum nitrate. Suitable sources of the structure directing agents may be selected from the hydroxides and/or salts of the relevant diquaternary ammonium compounds, e.g., 1,5-bis(N-propylpyrrolidinium) pentane dication, 1,6-bis(N-propylpyrrolidinium) hexane dication, 1,4-bis(N-methylpyrrolidinum) butane dication.

In one or more aspects, the mixture after solvent adjustment (e.g., where the desired water to silica molar ratio is achieved) may be mixed by a mechanical process such as stirring or high shear blending to assure suitable homogenization of the base mixture. For example, using a FlackTek speedmixer with a mixing speed of 1800 to 2200 rpm (e.g., 2000 rpm) can improve homogenization of the base mixture. Depending on the nature of the reagents in the base mixture, the amount of solvent (e.g., water) may be reduced in the mixture before crystallization to obtain the desired solvent molar ratio (e.g., H₂O/SiO₂). Suitable methods for reducing the solvent (e.g., water) content may include evaporation under a static or flowing atmosphere such as ambient air, dry nitrogen, dry air, or by spray drying or freeze drying. In one or more aspects, using silica sources such as LUDOX® (e.g., LUDOX® AS-40), ULTRASIL®, CARBOSPERSE™, or a mixture thereof, with a mixing speed of 1800 to 2200 rpm (e.g., 2000 rpm), may produce a base mixture with the desired solvent molar ratio (e.g., H₂O/SiO₂ molar ratio) without having to remove solvent from the base mixture. High mixing speeds such as 2000 rpm can produce homogenization of the mixture even when the mixture has a solvent molar ratio (e.g., H₂O/SiO₂ molar ratio) of greater than 10 (e.g., 15 to 40).

Crystallization of EMM-23 in the formation of the as-made EMM-23 may be carried out under static or stirred conditions in a suitable reactor vessel, such as for example, polypropylene jars or Teflon lined or stainless steel autoclaves placed in a convection oven maintained at a temperature of about 100 to about 200° C. for a period of time sufficient for crystallization to occur at the temperature used, e.g., from about 1 day to about 14 days. Thereafter, the solid crystals of the as-made EMM-23 are separated from the liquid (e.g., by filtration or centrifugation) and recovered.

Part or all of the SDA when used during the synthesis of an as-made EMM-23 may be removed to form the calcined EMM-23. Removal of SDA may be carried out using thermal treatment (e.g., calcination) in which the as-made EMM-23 material is heated in an atmosphere selected from air, nitrogen, or a mixture thereof at a temperature sufficient to remove part or all of the SDA. While sub-atmospheric pressure may be employed for the thermal treatment, atmospheric pressure is desired for reasons of convenience. The thermal treatment may be performed at a temperature up to 650° C., e.g., from 400-600° C. The thermal treatment (e.g., calcination) may be carried out in a box furnace in dry air, which has been exposed to a drying tube containing drying agents that remove water from the air. The thermally-treated EMM-23 materials (e.g., the calcined product) can be useful in the catalysis of certain organic, e.g., hydrocarbon, conversion reactions.

EWT framework zeolites (e.g., the as-made, calcined, modified, unmodified, or any other form of EWT framework zeolites) can be combined with a hydrogenating component. The hydrogenating component may be selected from molybdenum, tungsten, rhenium, nickel, cobalt, chromium, manganese, or a noble metal, such as platinum or palladium where a hydrogenation-dehydrogenation function is to be performed. Such hydrogenating components may be incorporated into the composition by way of one or more of the following processes: co-crystallizing; exchanging into the composition to the extent a Group IIIA element, e.g., aluminum, is in the structure; impregnating therein; or physically admixing therewith. For example, such hydrogenating components may be impregnated into the EWT framework zeolite. In the case of platinum, the EWT framework zeolite may be impregnated with a solution containing a platinum metal-containing ion. Suitable platinum compounds for impregnating may be selected from chloroplatinic acid, platinous chloride, and compounds containing a platinum amine complex. Combinations of all aspects stated above, e.g., use of heat and vacuum, are efficient processes to dehydrate, at least partially, EWT framework zeolites.

EWT framework zeolites (e.g., the as-made, calcined, modified, unmodified, or any other form of EWT framework zeolites), when employed either as an adsorbent or as a catalyst, may be dehydrated, at least partially. Such dehydration may be accomplished by heating the EMM-23 in a surrounding atmosphere at a temperature in the range of 200 to 370° C., the atmosphere may be selected from air, nitrogen, or a mixture thereof, and at atmospheric, sub-atmospheric or superatmospheric pressures for between 30 minutes and 48 hours. Dehydration may also be performed at room temperature by placing the EWT framework zeolite in a vacuum; however, a longer period of time is required to obtain a sufficient amount of dehydration. Combinations of all aspects stated above, e.g. use of heat and vacuum, are efficient processes to dehydrate, at least partially, EWT framework zeolites.

As mentioned above, in a third aspect, the invention provides a process of converting an organic compound to a conversion product which comprises the step of contacting the organic compound with an EWT framework zeolite according the second aspect.

The EWT framework zeolites, for example, EMM-23 (e.g., the as-made, calcined, modified, unmodified, or any other form of EWT framework zeolite) may be used as an adsorbent or in an aluminosilicate form, as a catalyst to catalyze a wide variety of organic compound conversion processes. Examples of chemical conversion processes, which are effectively catalyzed by the treated EWT framework zeolite of the second aspect of the invention, either alone or in combination with one or more other catalytically active substances (including other crystalline catalysts), include those requiring a catalyst with acid activity. Examples of organic conversion processes, which may be catalyzed by the EWT framework zeolites of the second aspect of the invention include cracking, hydrocracking, disproportionation, alkylation, oligomerization, and isomerization.

EWT framework zeolites (e.g., the as-made, calcined, modified, unmodified, or any other form of EWT framework zeolite) may be incorporated with another material resistant to the temperatures and other conditions employed in organic conversion processes. Such resistant materials may be selected from active materials, inactive materials, synthetic zeolites, naturally occurring zeolites, inorganic materials or a mixture thereof. Examples of such resistant materials may be selected from clays, silica, metal oxides such as alumina, or a mixture thereof. The inorganic material may be either naturally occurring, or in the form of gelatinous precipitates or gels, including mixtures of silica and metal oxides. Use of a resistant material in conjunction with an EWT framework zeolite, i.e., combined therewith or present during synthesis of the as-made zeolite crystal, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays, e.g., bentonite and kaolin, to improve the crush strength of the catalyst under commercial operating conditions. Said inactive resistant materials, i.e., clays, oxides, etc., function as binders for the catalyst. A catalyst having good crush strength can be beneficial because in commercial use, it is desirable to prevent the catalyst from breaking down into powder-like materials.

Naturally occurring clays which may be composited with EWT framework zeolites such as EMM-23 include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays may be used in the raw state as originally mined or initially subjected to calcination, acid treatment or chemical modification. Binders useful for compositing with EWT framework zeolites such as EMM-23 also include inorganic oxides selected from silica, zirconia, titania, magnesia, beryllia, alumina, or a mixture thereof.

EWT framework zeolites (e.g., the as-made, calcined, modified, unmodified, or any other form of EWT framework zeolite) may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia, and silica-magnesia-zirconia.

The relative proportions of EWT framework zeolite and inorganic oxide matrix may vary widely, with the EWT framework zeolite content ranging from about 1 to about 90 percent by weight, of the composite or, when the composite is prepared in the form of beads, in the range of about 2 to about 80 weight percent of the composite.

In one or more aspects, embodiments described herein using the language a “material comprising” with respect to a particular composition is meant to include a “material comprising or being” the particular composition.

As used herein, and unless otherwise specified, a numeric value or range of values may deviate to an extent deemed reasonable to one of ordinary skill in the relevant art. It is well known that instrument variation and other factors can affect the numerical values. Such deviation, unless otherwise specified, may be plus or minus 2%, 5%, 10%, 15%, 20%, 25%, or 30% of the numeric value or range of values indicated.

As used herein, the term “substantially free” refers to the materials described herein (e.g., EWT framework zeolites) are at least 50%, at least 60%, at least 70%, at least 80%, at least 90%, at least 95%, at least 97%, or at least 99% (e.g., 99.5% or 99.9%) by weight pure EWT framework zeolite material, based on the total weight of the composition, by quantification using XRD or NMR spectroscopy (e.g., by measuring the area or the relative intensity of the relevant peaks), or by other known methods appropriate for such determination. The remainder of the material is non-EWT framework zeolite material, which may be structure directing agent, amorphous material, other impurities, or a mixture thereof.

As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, crystalline EMM-23 can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content.

As used herein, the term “substantially crystalline” means a majority (greater than 50%) of the weight of a sample of a solid material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

### Analytical Methods

Inductively Coupled Plasma (ICP) analysis combined with mass spectrometry (ICP-MS) technique was used to assess the elemental compositions of samples. 50 mg of the samples were first digested using mixture of aqua regia (mixture of HCl and HNO₃) and HF, in closed PTEF vessels at 90° C. Mixture was then neutralized by adding H₃BO₄. The obtained solutions were diluted in a jauged volume of 1000 cm³, atomized/ionized using high energy Ar-plasma, and then accelerated in a mass spectrometer to allow acquisition of mass spectrum of the analyte solution.

Solid State NMR measurements were recorded on a Bruker Avance 500 spectrometer with 4-OD mm zirconia rotors and spinning speeds of 14 kHz. 27Al MAS NMR spectra were obtained from fully hydrated zeolite samples using a short quantitative single pulse (π/12) at 130.3 MHz, a recycle delay of 1 s and 1856 scans. An aqueous 1.0 M solution of Al (NO₃)₃ was used as an external reference (0 ppm). Spectra are normalized to 100 mg of the hydrated material.

Acidity-Pyridine adsorption was used to evaluate acidity of the samples. This study was performed using a standard in-situ Fourier transform infrared (FTIR) set-up. Infrared spectra were recorded on a Nicolet Magna 550 FTIR spectrometer equipped with a DTGS detector at 4 cm⁻¹ optical resolution, with one level of zero-filling for the Fourier transform. Prior to the measurement, the sample was ground and pressed into a self-supporting disc (2 cm diameter, approximately 5 mg cm⁻²) and activated under vacuum (ca. 10⁻⁶ hPa) at 450° C. for 4h (2° C. min⁻¹.) After cooling to room temperature, sample spectrum was recorded as reference. Then, a saturation pressure of the probe molecule (1 torr of Pyridine) was established in the cell at ambient temperature to reach saturation. The wafer was heated at 150° C. for 30 min to facilitate diffusion of probe molecule into the sample. Successive evacuations were performed at room temperature, 150° C., 200° C., 250° C., 300° C., and 350° C. at 15 min intervals. All spectra were normalized to 20 mg of dehydrated zeolite. The amounts of Lewis sites (L) and Brønsted (B) sites were determined using the band areas from the coordinated pyridine at 1450 cm⁻¹ and that of the adsorbed pyridinium at 1545 cm⁻¹, respectively. The molar extinction coefficients (E) used for quantification were taken from Guisnet et al.: § 1545 (B-pyridine)=1.13 cm μmol⁻¹ and €1455 (L-pyridine)=1.28 cm μmol⁻¹. OMNIC version 7.3 SP1 program was used for data processing.

As used herein, the term “alpha value” refers to the catalytic activity of a material (e.g., the EWT framework zeolites described herein) measured by the ratio of the rate constant of a test sample for cracking normal hexane to the rate constant of a standard reference catalyst, which is optionally an amorphous silica/alumina. See e.g., P. B. Weisz and J. N. Miale, J. Catalysis, 4 (1965) 527-529; and J. N. Miale, N. Y. Chen, and P. B. Weisz, J. Catalysis, 6 (1966) 278-287. For example, an alpha value of 1 means that the test sample and the reference standard have about the same activity. In one or more aspects, the treated EWT framework zeolite according to the second aspect of the invention, may have an alpha value of greater than 10.

The micropore volume of the modified EWT framework zeolites described herein can be determined using methods known in the relevant art. For example, the materials can be measured with nitrogen physisorption, and the data can be analyzed by the t-plot method described in Lippens, B. C. et al., “Studies on pore system in catalysts: V. The t method”, J. Catal., 4, 319 (1965), which describes micropore volume method and is incorporated herein by reference. Using such nitrogen physisorption method, the treated EWT framework zeolites of the second aspect of the invention may have a micropore volume of 0.15 to 0.30, 0.25 to 0.30 cc/g, or 0.20 to 0.30 cc/g.

The X-ray diffraction data reported herein were collected by powder X-ray diffraction (PXRD) using a PANalytical X'Pert Pro diffractometer with average Cu Kα radiation ( )=1.5418 Å). We used a 0-20 scan in the 3-50° 20-range and a 0.02° step. The instrumental contribution to the line broadening was calibrated on the LaB6 srm660b standard powder from the National Institute of Standards and Technology. The interplanar spacings, d-spacings, were calculated in Angstrom units, and the relative intensities of the lines, I/I_{O} is the ratio of the peak intensity to that of the intensity of the strongest line, above background. The intensities are uncorrected for Lorentz and polarization effects. The interplanar spacings, d-spacings, were calculated in Angstrom units, and the relative peak area intensities of the lines, I/I₍ₒ₎, is one-hundredth of the intensity of the strongest line, above background, were determined with the MDI Jade peak profile fitting algorithm. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the structure. These minor effects, including changes in relative intensities, can also occur as a result of differences in cation content, framework composition, nature and degree of pore filling, crystal size and shape, preferred orientation and thermal and/or hydrothermal history.

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results.

### EXAMPLES

In the following, Examples 1 and 2 are reference examples disclosing the preparation of as-made and calcined EMM-23, respectively. Examples 3, 6, 7, 13 and 15 are reference examples disclosing single treatments of calcined EMM-23 with solutions comprising aluminum salts. Examples 4, 5, 14 and 16 are reference examples disclosing single treatments of as-made EMM-23 with solutions comprising aluminum salts. Examples 8 to 12 are according to the invention and disclose repeated treatments of calcined EMM-23 with a solution comprising an aluminum salt.

### Example 1—Hydrothermal Synthesis of as-Made EMM-23

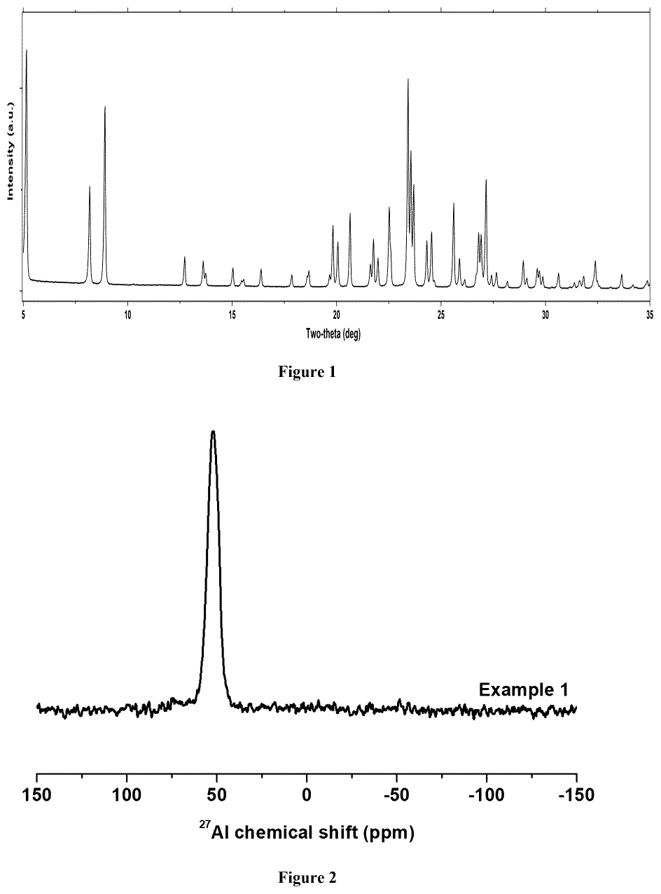

37.3 g of 15% aluminum nitrate solution was dissolved in 1211.5 g of 22.4 wt % 1,1-(pentane-1,5-diyl)bis(1-propylpyrrolidinium) hydroxide. 1.9 g of EMM-23 seeds was added to the aluminate solution and stirred until the seeds were well distributed. With vigorous stirring, 499.0 g of tetramethylorthosilicate (TMOS) was slowly added to the seed containing aluminate solution. The mixture was agitated for 30 min to completely hydrolyze the TMOS. To obtain the proper H₂O/SiO₂ ratio, the weight of the mixture was reduced to 765.3 g by heating at 75° C. in a forced air drying oven. The mixture was transferred to a 2 L stirred autoclave. While stirring at 250 rpm the mixture was heated to 150° C. After reacting the slurry for 120 h at 150° C. the resulting crystalline product was separated from any liquids via vacuum filtration and washed with three reactor volumes of water. After drying on the vacuum filter, the wet cake was dried at 120° C. for 16 h to produce a dry cake. Powder XRD (see FIG. 1) and elemental analysis via AA/ICP indicates that the material produced was EMM-23 with a Si:Al₂ ratio of ca. 400. FIG. 2 shows the 27 Al MAS NMR spectrum of the as-made EMM-23 prepared in Example 1.

### Example 2—Calcination of the as-Made EMM-23 from Example 1

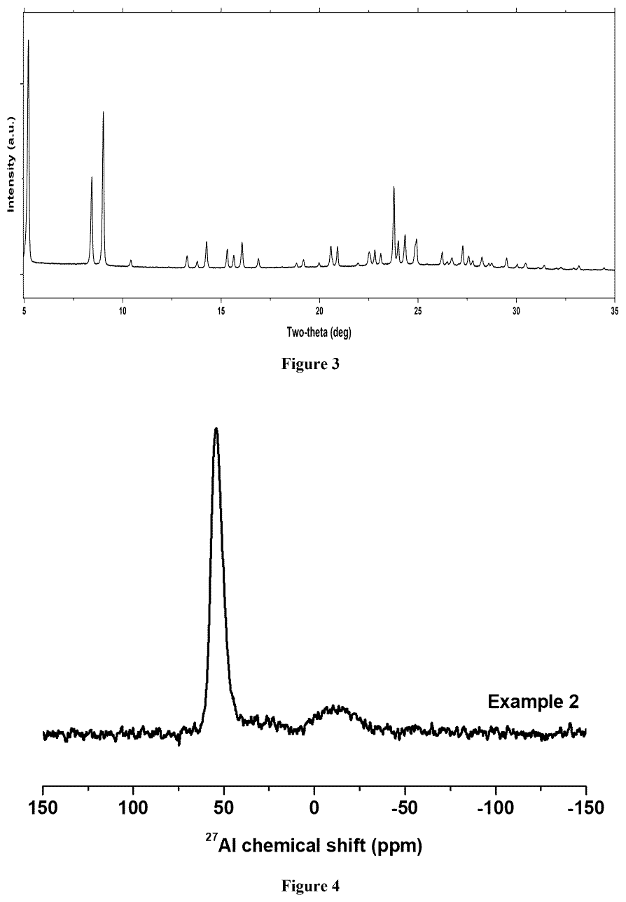

A sample of the as-made EMM-23 of Example 1 was heated inside a muffle furnace from ambient temperature to 400° C. with a heating rate of 4° C. min-1 under 100 cm³ min⁻¹ nitrogen flow. Then, nitrogen was gradually switched to air while the temperature was increased to 540° C., using the same heating rate, and maintained at 540° C. for 2 h under air flow. FIG. 3 shows the powder XRD pattern of the calcined EMM-23 prepared in Example 2 and FIG. 4 shows its 27Al MAS NMR spectrum.

### Example 3—Treatment of Calcined EMM-23 with AlCl₃.6H₂O

A sample of the calcined EMM-23 of Example 2 was subjected to following post-synthesis alumination. Post-synthesis alumination was carried out with 0.4 wt % AlCl₃.6H₂O solution at solid:liquid ratio of 1:50. The mixture was stirred overnight at 80° C. with a stirring rate of 400 rpm. After treatment, the sample was purified by a series of high-speed centrifugation/decanting of the supernatant and re-dispersion of the sample under ultrasonic treatment (UT,) following this protocol: 1) Centrifugation/decanting at 20000 rpm for 20 min; 2) Washing with water, re-dispersion under ultrasonic treatment (UT) duration 10 min, centrifugation/decanting at 20000 rpm for 20 min; 3) Washing with 0.1 M NH₄OH, UT=20 min, centrifugation/decanting at 20000 rpm for 20 min; and 4) Four times washing with water, UT, and centrifugation/decanting at 20000 rpm for 20 min each time.

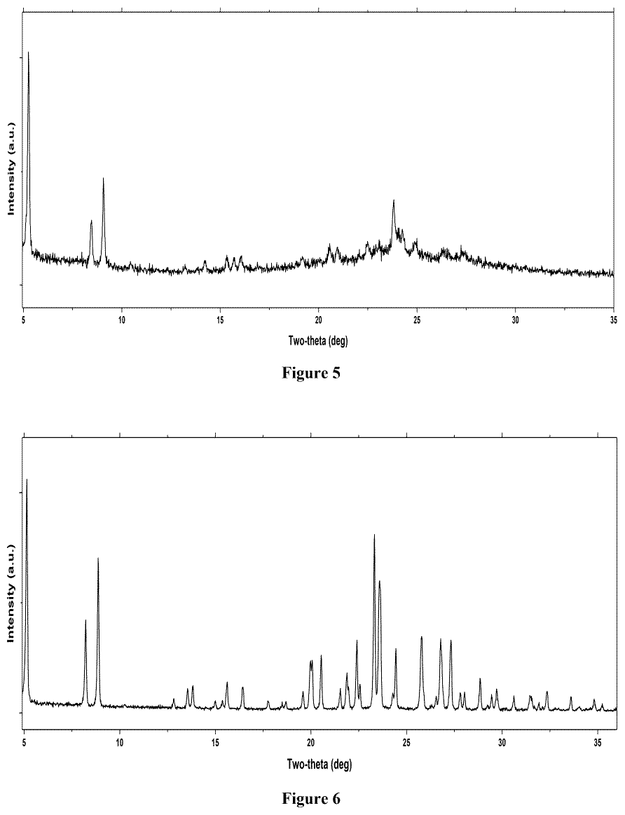

The treated EMM-23 was then dried overnight in an oven at 60° C. The powder XRD pattern is shown in FIG. 5.

### Example 4—Treatment of As-Made EMM-23 with AlCl₃.6H₂O

A sample of the as-made EMM-23 prepared in Example 1 was subjected to the treatment described in Example 3. The powder XRD pattern is shown in FIG. 6.

### Example 5—Treatment of As-Made EMM-23 with AlCl₃.6H₂O with Water Washes

A sample of the as-made EMM-23 of Example 1 was subjected to the post-synthesis alumination described in Example 3. However, the sample was not washed with NH₄OH. Instead, it was washed six times with only H₂O in order to keep the number of washing steps similar to that in Example 3. The obtained sample was then dried overnight in an oven at 60° C. The powder XRD pattern is shown in FIG. 7.

### Example 6-Treatment of Calcined EMM-23 with AlCl₃.6H₂O with Water Washes

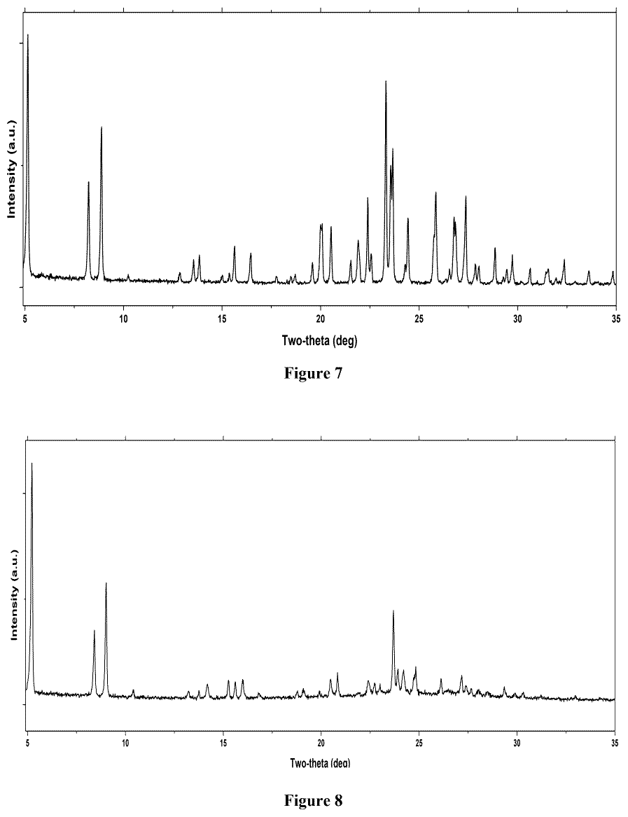

A sample of calcined EMM-23 of Example 2 was subjected to the post-synthesis alumination described in Example 3. However, sample was not washed with NH₄OH. Instead, it was washed six times with only H₂O in order to keep the number of washing steps similar to that in Example 3. The obtained sample was then dried overnight in an oven at 60° C. The powder XRD pattern is shown in FIG. 8.

Example 7-Treatment of Calcined EMM-23 with AlCl₃.6H₂O

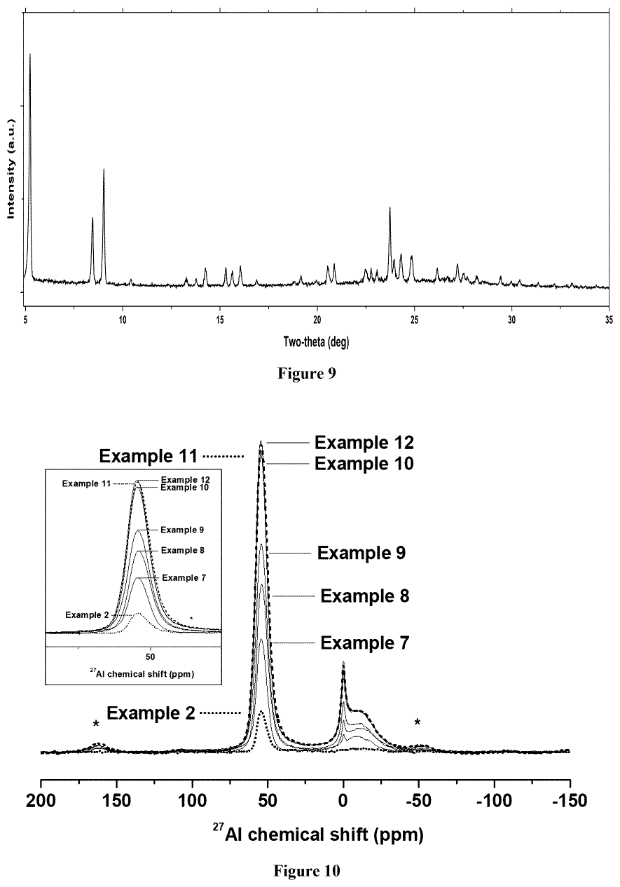

A sample of the calcined EMM-23 prepared in Example 2 was subjected to following post-synthesis alumination treatment. The treatment was carried out with 0.4 wt % AlCl₃.6H₂O solution at solid:liquid ratio of 1:50. The mixture was stirred at 80° C. for 3 h with a stirring rate of 400 rpm. After treatment, the sample was purified by a series of three steps of high-speed centrifugation/decanting of the supernatant and re-dispersion of the sample in water under ultrasonic treatment (15 min each time.) The treated EMM-23 was then dried overnight in an oven at 60° C. The powder XRD pattern is shown in FIG. 9.

Examples 8 to 12—Repeated Treatment of Calcined EMM-23 with AlCl₃.6H₂O

In Example 8 a sample of the treated EMM-23 prepared in Example 7 was subjected for a second time to the same treatment described in Example 7. In Example 9 a sample of the treated EMM-23 prepared in Example 8 was subjected for a third time to the same treatment described in Example 7. In Example 10 a sample of the treated EMM-23 prepared in Example 9 was subjected for a fourth time to the same treatment described in Example 7. In Example 11 a sample of the treated EMM-23 prepared in Example 10 was subjected for a fifth time to the same treatment described in Example 7. In Example 12 a sample of the treated EMM-23 prepared in Example 11 was subjected for a sixth time to the same treatment described in Example 7.

FIG. 10 shows 27Al MAS NMR spectrum of calcined EMM-23 prepared in Example 2 and the treated EMM-23 of Examples 7 to 12. (The small peaks marked with * are spinning sidebands.)

### Example 13—Treatment of Calcined EMM-23 with AlNO₃.9H₂O

A sample of the calcined EMM-23 prepared in Example 2 was subjected to following post-synthesis alumination treatment. The treatment was carried out with 0.25 M AlNO₃.9H₂O solution at solid:liquid ratio of 1:50. The mixture was stirred overnight at 80° C. with a stirring rate of 400 rpm. After treatment, the sample was purified by a series of six high-speed centrifugation/decanting of the supernatant and re-dispersion of the sample in water under ultrasonic treatment, 15 min each time. The treated EMM-23 was then dried overnight in an oven at 60° C.

### Example 14—Treatment of as-Made EMM-23 with AlNO₃.9H₂O

A sample of the as-made EMM-23 prepared in Example 1 was subjected to the alumination treatment described in Example 13.

### Example 15—Treatment of Calcined EMM-23 with (NH₄)₃AlF₆

A sample of the calcined EMM-23 prepared in Example 2 was subjected to the following post-synthesis alumination treatment. The treatment was carried out with 0.02 M (NH₄)₃AlF₆ solution at solid:liquid ratio of 1:30. The mixture was stirred overnight at 25° C. with a stirring rate of 400 rpm. After treatment, the sample was purified by a series of three steps of high-speed centrifugation/decanting of the supernatant and re-dispersion of the sample in hot water under ultrasonic treatment, for 15 min each time. The obtained treated EMM-23 was then dried overnight in an oven at 60° C.

### Example 16—Treatment of As-Made EMM-23 with (NH₄)₃AlF₆

A sample of the as-made EMM-23 prepared in Example 1 was subjected to the following post-synthesis alumination treatment. The treatment was carried out with 0.02 M (NH₄)₃AlF₆ solution at solid:liquid ratio of 1:30. The mixture was stirred at RT under ultrasonic treatment for 30 min. After treatment, the sample was purified by a series of three steps of high-speed centrifugation/decanting of the supernatant and re-dispersion of the sample in hot water under ultrasonic treatment, for 15 min each time. The obtained treated EMM-23 was then dried overnight in an oven at 60° C.

### Discussion

The Si:Al₂ ratio and the Brønsted acidity of the materials obtained in Examples 1 to 16 are listed in Table 7, below.

TABLE 7

| | | Brønsted acid |
|---|---|---|
| Example | Si:Al₂^{a} | μmol g⁻¹ |
| 1 | N.A.^{b} | N.A. |
| 2 | 375 | 17 |
| 3 | 60 | 140 |
| 4 | N.A. | N.A. |
| 5 | N.A. | N.A. |
| 6 | 71 | 93 |
| 7 | 87 | 86 |
| 8 | 55 | N.A. |
| 9 | 40 | N.A. |
| 10 | 37 | 183 |
| 11 | 35 | 189 |
| 12 | 30 | 218 |
| 13 | 70 | 115 |
| 14 | N.A. | N.A. |
| 15 | 340 | N.A. |
| 16 | 141^{d} | N.A. |

^{a} Si:Al₂ ratio obtained from ICP-MS;
^{b} Not analyzed;
^{c} To be analyzed;
^{d}Approximation from EDS.

The results in Table 7 reveal that the calcined EMM-23 zeolite prepared in Example 2 had a Si:Al₂ ratio of 375, indicating that very little Al had been incorporated into the zeolite during crystallization. Example 3 indicates that an overnight treatment of the zeolite with a solution of an aluminum salt leads to an increase in the amount of Al in the zeolite such that the Si:Al₂ ratio decreased to 60. Example 6 reveals a similar result. Example 7 indicates that a single 3 hour treatment also gives an increase in the Al concentration in the zeolite, but not to the same extent as the overnight treatment of Example 3.

Examples 8 to 12 show that repeated treatments lead to a progressive increase in the concentration of Al in the zeolite, but that the degree of increase with each treatment generally reduces as the number of repeats n goes from n=2 (Example 8) to n=6 (Example 12). Surprisingly, even at a total treatment time of only 6 hours (n=2, Example 8), the Si:Al₂ ratio is already lower than for the longer, overnight treatments of Examples 3 and 6.

Examples 3, 6 and 7 to 12 illustrate treatment of the zeolite with AlCl₃.6H₂O. Examples 14 and 16 illustrate the treatment of the zeolite with AlNO₃.9H₂O and (NH₄)₃AlF₆, respectively.

Examples 4 and 5 show that treatment with a solution of aluminum chloride is also effective to increase the aluminum content of the as-made zeolite. Examples 14 and 16 illustrate treatment of the as-made zeolite with AlNO₃.9H₂O and (NH₄)₃AlF₆, respectively.

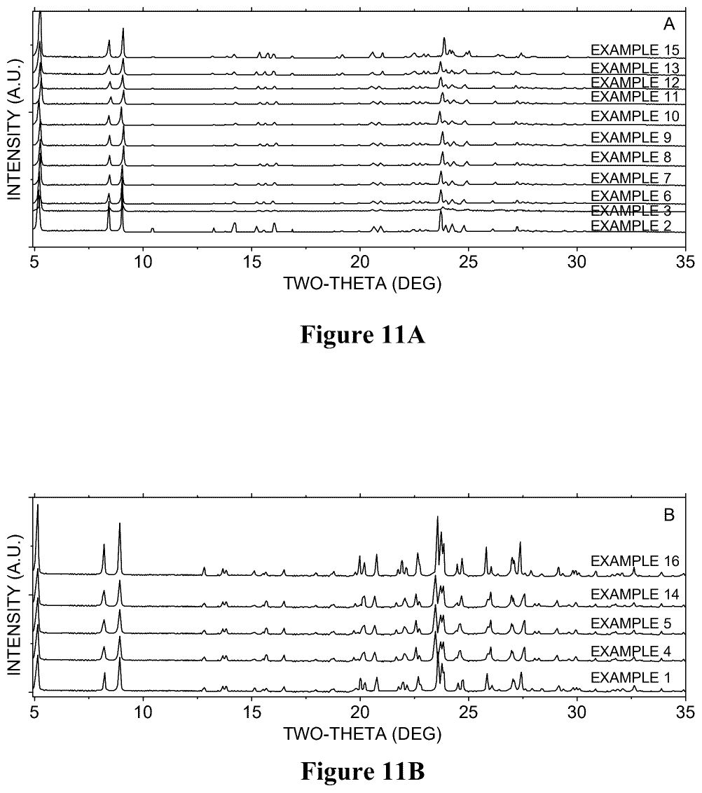

FIG. 11A shows overlaid powder XRD patterns of calcined EMM-23 prepared in Examples 2, 3, 6 to 13 and 15. FIG. 11B shows overlaid powder XRD patterns of as-made EM-23 prepared in Examples 1, 4, 5, 14 and 16.

Various modifications of the disclosure, in addition to those described herein, will be apparent to those skilled in the art from the foregoing description. Such modifications are also intended to fall within the scope of the appended claims. Each reference, including without limitation all patent, patent applications, and publications, cited in the present application is incorporated herein by reference in its entirety.

Additionally or alternately, the invention relates to:

Embodiment 1: A process for increasing the aluminum content of an EWT framework zeolite and mixtures thereof comprising subjecting the EWT framework zeolite to a treatment which includes the steps of:
a) contacting the EWT framework zeolite with an aqueous solution of an aluminum salt; and
b) separating the EWT framework zeolite from the aqueous solution of the aluminum salt;
and repeating the treatment such that the EWT framework zeolite is subjected in total to n treatment cycles, where n is a number in the range from 2 to 10.

Embodiment 2: The process of embodiment 1, in which in step a) the EWT framework zeolite is contacted with the aqueous solution of the aluminum salt for a duration in the range of from 1 hour to 24 hours.

Embodiment 3: The process of embodiment 1 or 2, in which the aluminum salt is selected from the group consisting of Al₂ (SO₄)₃, AlCl₃, Al(NO₃)₃, (NH₄)₃AlF₆ and mixtures thereof.

Embodiment 4: The process of any of embodiments 1 to 3, in which in one or more of the treatment cycles the treatment also includes after step b) the step of: c) washing the EWT framework zeolite with a wash liquid.

Embodiment 5: The process of embodiment 4, in which in at least one treatment cycle the wash liquid is water.

Embodiment 6: The process of embodiment 4 or 5, in which in at least one treatment cycle the wash liquid is aqueous ammonium hydroxide.

Embodiment 7: The process of any of embodiments 1 to 6, in which in one or more of the treatment cycles the treatment also includes after step b), or if present, step c), the step of: d) drying the EWT framework zeolite.

Embodiment 8: The process of any of embodiments 1 to 7, in which during step a) the contacting is carried out at a temperature in the range of from 50° C. to 100° C.

Embodiment 9: The process of any of embodiments 1 to 8, in which n is from 3 to 6.

Embodiment 10: The process of any of embodiments 1 to 9, in which the EWT framework zeolite is a calcined EWT framework zeolite.

Embodiment 11: The process of any of embodiments 1 to 10, in which the EWT framework zeolite is an uncalcined EWT framework zeolite.

Embodiment 12: The process of any of embodiments 1 to 11, in which the EWT framework zeolite is EMM-23.

Embodiment 13: The process of any of embodiments 1 to 12, in which the EWT framework zeolite is in the form of unbound zeolite crystals.

Embodiment 14: An EWT framework zeolite produced by a process according to any preceding embodiment, in which the ratio Si:Al₂ is 70 or lower.

Embodiment 15: A process of converting an organic compound to a conversion product which comprises the step of contacting the organic compound with an EWT framework zeolite according to embodiment 14.

1. A process for increasing the aluminum content of an EWT framework zeolite and mixtures thereof comprising subjecting the EWT framework zeolite to a treatment which includes the steps of:
a) contacting the EWT framework zeolite with an aqueous solution of an aluminum salt; and
b) separating the EWT framework zeolite from the aqueous solution of the aluminum salt;
and repeating the treatment such that the EWT framework zeolite is subjected in total to n treatment cycles, where n is a number in the range from 2 to 10.

2. The process of claim 1, in which in step a) the EWT framework zeolite is contacted with the aqueous solution of the aluminum salt for a duration in the range of from 1 hour to 24 hours.

3. The process of claim 1, in which the aluminum salt is selected from the group consisting of Al₂(SO₄)₃, AlCl₃, Al(NO₃)₃, (NH₄)₃AlF₆ and mixtures thereof.

4. The process of claim 1, in which in one or more of the n treatment cycles, the treatment also includes after step b) the step of:
c) washing the EWT framework zeolite with a wash liquid.

5. The process of claim 4, in which in at least one treatment cycle of the n treatment cycles, the wash liquid is water.

6. The process of claim 4, in which in at least one treatment cycle of the n treatment cycles, the wash liquid is aqueous ammonium hydroxide.

7. The process of claim 1, in which in one or more of the n treatment cycles, the treatment also includes after step b), or if present, after step c), the step of:
d) drying the EWT framework zeolite.

8. The process of claim 1, in which during step a) the contacting is carried out at a temperature in the range of from 50° C. to 100° C.

9. The process of claim 1, in which n is from 3 to 6.

10. The process of claim 1, in which the EWT framework zeolite is a calcined EWT framework zeolite.

11. The process of claim 1, in which the EWT framework zeolite is an uncalcined EWT framework zeolite.

12. The process of claim 1, in which the EWT framework zeolite is EMM-23.

13. The process of claim 1, in which the EWT framework zeolite is in the form of unbound zeolite crystals.

14. The process of claim 1, wherein the EWT framework zeolite has a molar ratio of Si:Al₂ of 70 or lower.

15. An EWT framework zeolite produced according to the process of claim 1, in which the EWT framework zeolite has a molar ratio of Si:Al₂ of 70 or lower.

16. The EWT framework zeolite of claim 15, wherein the EWT framework zeolite is EMM-23.

17. A process of converting an organic compound to a conversion product, comprising:
contacting the organic compound with an EWT framework zeolite having a molar ratio of Si:Al₂ of 70 or lower, the EWT framework zeolite formed by a process comprising:
a) contacting the EWT framework zeolite with an aqueous solution of an aluminum salt; and
b) separating the EWT framework zeolite from the aqueous solution of the aluminum salt;
and repeating the treatment such that the EWT framework zeolite is subjected in total to n treatment cycles, where n is a number in the range from 2 to 10.

18. The process of claim 17, in which in one or more of the n treatment cycles, the treatment also includes after step b) the step of:
c) washing the EWT framework zeolite with a wash liquid.

19. The process of claim 18, wherein i) in at least one treatment cycle of the n treatment cycles, the wash liquid is water, ii) in at least one treatment cycle of the n treatment cycles, the wash liquid is aqueous ammonium hydroxide, or iii) both i) and ii).

20. The process of claim 17, wherein during step a) the contacting is carried out at a temperature in the range of from 50° C. to 100° C.; or wherein n is from 3 to 6; or a combination thereof.
